(19) United States
(12) Patent Application Publication
(10) Pub. No.: US 2012/0249333 A1
(43) Pub. Date: Oct. 4, 2012

(54) SYSTEM AND METHOD FOR MONITORING PH OR OTHER CHEMICAL ACTIVITY IN A POOL

(76) Inventor: Christopher Gerard Kunis, Escondido, CA (US)

(21) Appl. No.: 13/437,625

(22) Filed: Apr. 2, 2012

Related U.S. Application Data
(60) Provisional application No. 61/469,986, filed on Mar. 31, 2011.

(51) Int. Cl. G08B 21/00; G06F 19/00; G01N 1/12

(52) U.S. Cl. 340/603; 73/61.59; 702/25

(57) ABSTRACT

Systems and methods are provided for monitoring the value of pH or another characteristic in situ within a pool. A housing sits in the pool and continuously or periodically or occasionally measures the value of the characteristic. An indicator is then provided according to the value of the characteristic, to indicate to the user the value, either quantitatively or qualitatively.

### CROSS REFERENCE TO RELATED APPLICATIONS

This application claims benefit of priority of U.S. Provisional Patent Application Ser. No. 61/469,986, filed Mar. 31, 2011, entitled “IN POOL PH MEASURING DEVICE”, which is hereby incorporated by reference in its entirety.

### BACKGROUND

Monitoring of the chemical levels in a pool, e.g., a recreational pool, is a necessary though tedious task. Samples must be drawn and chemical tests applied to yield results. In many cases, results are obtained by comparing obtained colors against reference standards. However, this technique relies to some extent on subjective user determinations.

Adults may become familiar with an acceptable chemical level, e.g., by smelling chlorine, but others who may use the pool, including children or dogs, generally cannot identify acceptable chemical levels and thus objective measurements are vital to their safety.

Consequently, there remains a need for a better method of monitoring pool chemical levels, including pH.

### SUMMARY

In one aspect, systems and methods according to the principles disclosed here relate to a pH monitoring device that may reside in situ in a pool, providing an indication of the pool's chemical characteristics without the need for a user to manually test for the same.

Systems and methods are provided for monitoring the value of pH or another characteristic in situ within a pool. A housing sits in the pool and continuously or periodically or occasionally measures the value of the characteristic. An indicator is then provided according to the value of the characteristic, to indicate to the user the value, either quantitatively or qualitatively.

The system may be sized in various ways, such as like a tennis ball, a large softball, or other sizes. A beacon or light may be provided to provide an indication to a user of the chemical characteristics, such as the pH level. It will be understood that in some implementations the monitoring device may be provided with a wireless transmitter so as to allow a reading of the chemical characteristics at a reception point, such as a poolside monitor or local network. In some implementations, an application may be provided on a smart phone or wireless PDA to allow access to the monitored data from any location.

Where the system employs a beacon or light, or where color is included as an aspect of the user interface of a wireless reception point, the color may represent the color on the pH scale indicating to the homeowner if chlorine or acid or the like needs to be added.

The ball may be left in the pool to float for, e.g., a 30 day period, and then the internal components may be replaced if needed to maintain an accurate pH indication.

The mechanism of action may be provided in a number of ways. It will further be noted that ways besides those listed below may also be employed, and the same will be apparent to one of ordinary skill in the art given this disclosure and its teachings.

In one system the device is embodied as a ball that includes or is made of (or coated with) material such as is used in pool testing strips. Such strips may be specially coated to allow the same to withstand extended durations in pool water. A small amount of test strip material may be metered out, and the same may be directly read by a user or the same may be read by mechanical means, followed by amplification if necessary and display at the beacon, light, or transmitter. The strip may be metered out so as to be in contact with pool water and then pulled back inside the ball. In this way, the strip gives an overall history of the chemical characteristics of the pool.

In many cases, it may be useful to have the strip read by optical or electrical means. For example, a colorimeter may be built into the ball that reads the color of the pH test strip, and then displays a light having a color intended to match that of the test strip. Alternatively, the same could emit a green light if it determines that the pH is within a predetermined range, and a red light otherwise. Many variations will be seen given this teaching.

It will be understood that pool water may make contact with the test strip by use of a micro pump that pulls the pool water into an analysis chamber.

In another implementation, the micro pump may pull water into an analysis chamber that is then read by an electronic pH tester. As before, based on the determined pH, a light or other indication may be provided telling the pool owner the results. In some cases, a memory may be maintained so that past results may be downloaded. In this way, historical knowledge of pH values, given chlorine and acid inputs, as well as, e.g., the season of the year, may be useful or interesting to the pool owners.

It is finally noted that various types of devices are available that may be incorporated in the in situ monitoring device to provide the types of measurements discussed above. Exemplary such devices are disclosed below:
www.poolguy.fr/products/testing.html
www.google.com/products/catalog?q=ph+pool+test+strips&oe=UTF-8&hl=en&client=safari&um=l&ie=UTF-8&cid=1671851883773700059&ei=₁₃ VUTaffGIr0tgOPqNHaBQ&sa=X&oi=product_catalog_result&ct=result&resnum=4&ved=0CEIQ8wIwAw#ps-sellers
www.wcponline.com/pdf/0911Sweazy.pdf

Advantages of the invention include that pH or other important chemical values may be determined in a convenient fashion, without the need for substantial user involvement as in prior systems.

Implementations of the invention are further described in the figures below.

### BRIEF DESCRIPTION OF THE DRAWINGS

FIG. 1 is a schematic depiction of a monitor ball according to the principles described here.

FIG. 2 is a more detailed depiction of a monitor ball according to the principles described here.

FIG. 3 is a more detailed depiction of a measurement device according to the principles described here.

FIG. 4 is a more detailed depiction of an alternative implementation of a measurement device according to the principles described here.

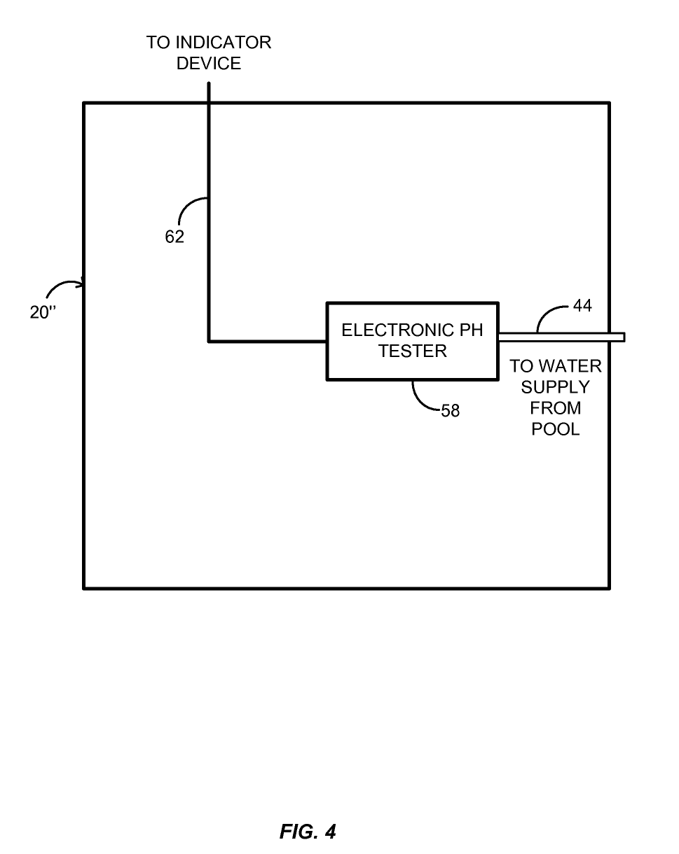

FIG. 5 is a flowchart of a method of using a monitoring ball according to the principles described here.

Like reference numerals reference to like elements throughout.

### DETAILED DESCRIPTION

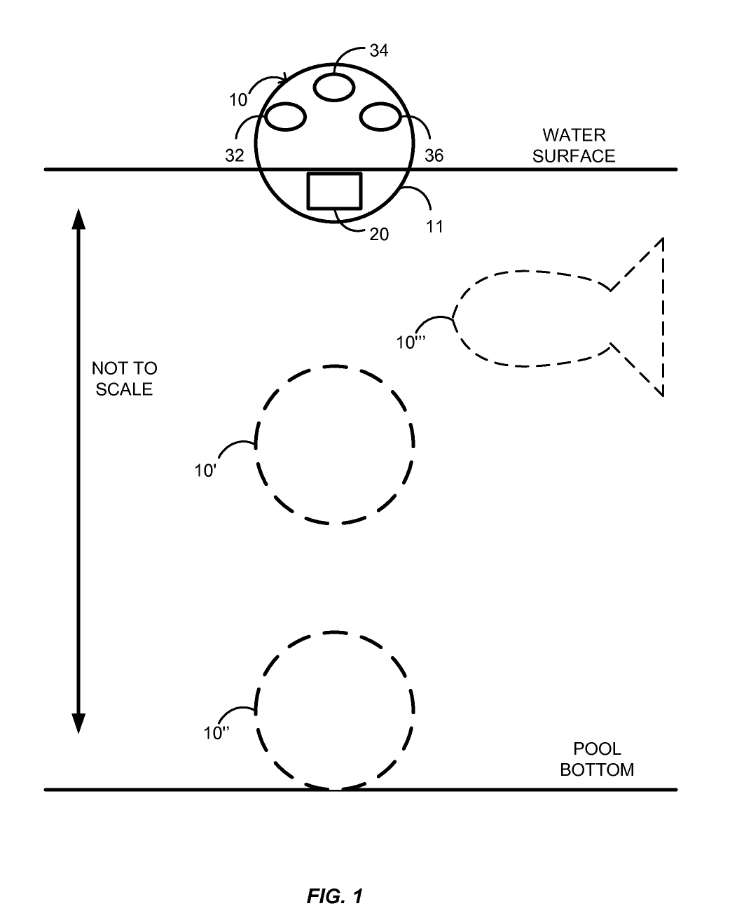

Referring to FIG. 1, an implementation of a system 10 is illustrated according to the principles described here. The system 10 includes a housing 11 within which the components of the system are disposed. Certain components may also be located on or otherwise coupled to the housing.

The housing 11 and various components may be configured such that the system 10 has a positive buoyancy (system 10), a neutral buoyance (10′), or even negative buoyance (10″). While a ball shape has been illustrated, it will be understood that other shapes may also be employed, including a fish shape 10′″.

A measurement device 20 is included, and the same generally receives a sample of water in some fashion, either passively (e.g., just via a hole in the housing) or actively (e.g., via a pump or micropump). The system 10 further includes one or more indicator devices, illustrated in FIG. 1 as an audio indicator device or audio emitter 32, which may be a speaker and a circuit configured to provide one or more audio analog signals to drive the speaker. For example, an unsatisfactory pH value may lead to an audio signal being emitted. Another indicator device that may be employed is a visual emitter 34, e.g., a light, e.g., an LED, and the light may be colored so as to indicate a pH value. For example, a green light may indicate an acceptable pH level, e.g., one with a value falling within a predetermined band of acceptable values. A red light may indicate an unacceptable pH level, e.g., one with a value falling outside of the predetermined band of acceptable values. A yellow light may indicate that action to adjust the pool water may need to be taken soon.

Yet another indicator device is illustrated, transmitter 36. The transmitter 36 may employ Bluetooth or another wireless technology in order to wirelessly transmit an indication of the pH to a receiver adjacent the pool, e.g., in a user's house next to the pool, etc. Such indication may subsequently result in an audio signal, visual signal, depicted value, a combination of these, or the like.

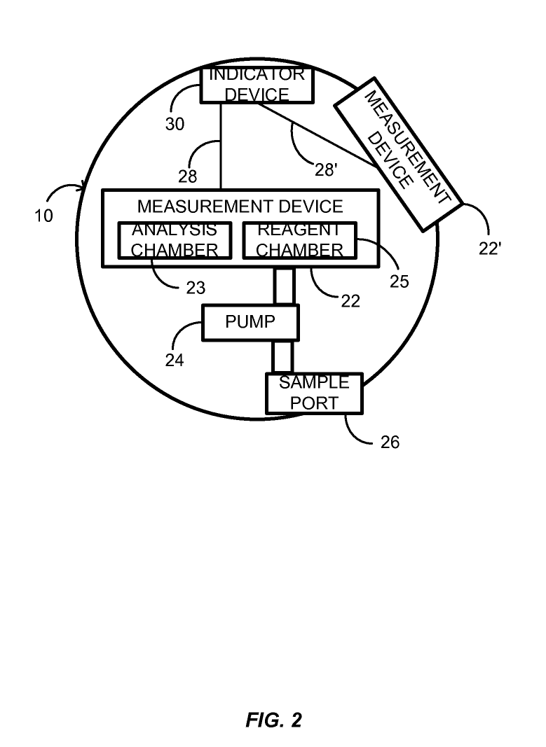

FIG. 2 illustrates a specific implementation of a system 10. The system 10 includes a measurement device 22, which in some implementations may include an analysis chamber 23 and a reagent chamber 25. Water from the pool may enter the housing through a sample port 26 and may be pulled by, e.g., a pump 24. In other implementations, the pressure of the water itself may cause the same to enter the housing. The measurement device with analysis chamber 22 is disposed within the housing, and may perform one or more tests on the water from the port 26 to determine a chemical (or other) characteristic thereof, e.g., pH, temperature, or the like. The tests may be performed in the analysis chamber 23 using optional reagents if required for the test from the reagent chamber 25.

A signal communication line 28 connects the measurement device 22 with an indicator device 30, which may be an emitter or beacon of the types noted above. In another implementation of the device, a measurement device 22′ may be employed, which is disposed coupled to or exterior of the housing. The measurement device 22′ requires no separate sample port as it may be directly incident with water. A similar signal communication line 28′ connects the measurement device 22′ with the indicator device 30.

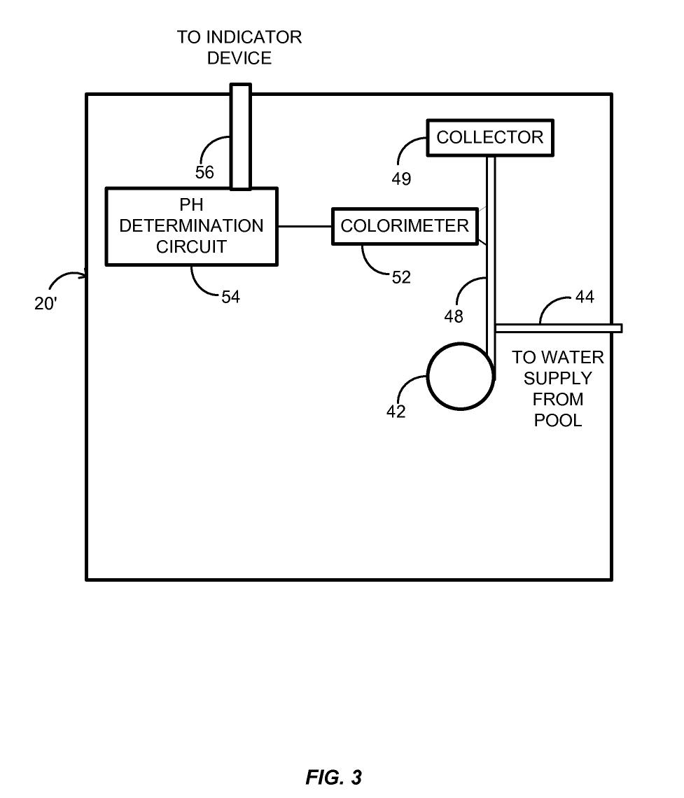

FIG. 3 illustrates one implementation of a measurement device 20′. The measurement device 20′ includes a port 44 for introduction of water. A pH monitoring strip is disposed on a continuous roll 42 and the same emerges from the roll and is configured to receive water from the port 44. The same passes by a colorimeter 52 and is received by a collector 49 to eliminate refuse in the pool. A motor may drive the roll or a motor, e.g., in the collector, may pull the strip off of the roll, or both.

The colorimeter 52 determines the color of the strip and uses the same to determine the pH or other chemical aspect of the water (different types of strips may determine different characteristics). For example, a pH determination circuit 54 may determine the pH given the color of the strip by, e.g., a look-up table or the like. A signal communication line 56 may then transmit an indication of the determined result to the indicator device to cause the same to render an indication of the pH or other determined characteristic.

In yet another implementation, illustrated by the measurement device 20″, the pH determination is performed by a separate device with no separate step of chemical analysis, e.g., an electronic pH tester 48 may receive a water sample from a port 44 and may directly determine the pH for subsequent indication by the indicator device using a signal communication line 62.

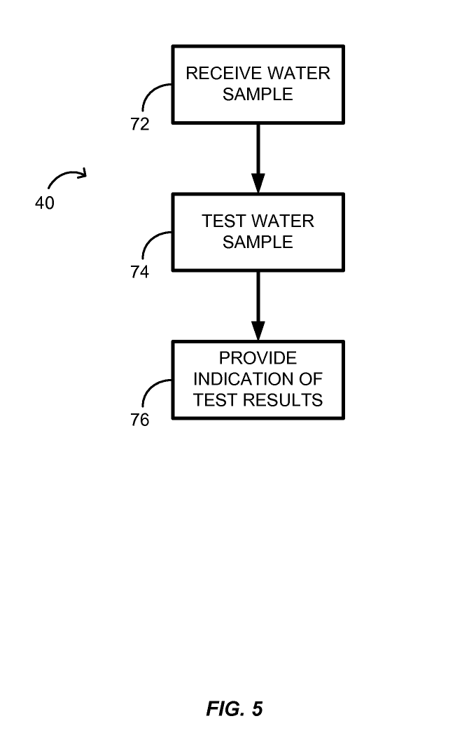

In a method according to principles described here, as illustrated by the flowchart 40 of FIG. 5, a first step is to draw a water sample from the pool (step 72). As noted above, the same may be via water pressure, gravity, pump, or the like. A next step is to test the water sample (step 74). The same may be via chemical analysis, colorimeter analysis of a pH strip, optical analysis, or other techniques. Of course, where other characteristics are monitored, tests may be adjusted accordingly to accomplish such purposes. A next step is to provide an indication of the test results (step 76). As noted above, the indication may be by way of audio cues, visual cues, transmission to a receiver, or the like. Variations of the method will be understood.

While the system and method have been described in the context of pH values, it will be understood that other chemical values may also be determined and indicated, with an appropriate measurement device. For example, the system and method may be employed to measure and monitor temperature, an amount of incident UV light, and the like. Accordingly, the invention is not limited to only the specific embodiments described above.

1. A device configured to reside in a pool and to monitor at least a pH level of water within the pool, comprising:
a housing;
a measurement device coupled to the housing and configured to receive a portion of water in an environment, the measurement device configured to determine a pH level corresponding to the portion of water; and
an indicator device coupled to the housing and in signal communication with the measurement device, such that the indicator device is configured to inform a user of a pH level within the pool.

2. The device of claim 1, wherein the measurement device is disposed within the housing.

3. The device of claim 1, wherein the measurement device is disposed on the exterior of the housing.

4. The device of claim 1, wherein the housing is in the shape of a ball.

5. The device of claim 1, wherein the housing is in the shape of a fish.

6. The device of claim 1, wherein the housing is configured to have positive buoyancy.

7. The device of claim 1, wherein the housing is configured to have negative buoyancy.

8. The device of claim 1, wherein the housing is configured to have neutral buoyancy.

9. The device of claim 1, wherein the indicator device is a light which when illuminated has a characteristic indicative of the determined pH.

10. The device of claim 9, wherein the characteristic is a color or an intensity.

11. The device of claim 1, wherein the indicator device includes a signal transmitter configured to transmit a signal to a receiver, the signal indicative of the pH.

12. The device of claim 1, wherein the indicator device includes an audio speaker which renders an audio signal when a determined pH is outside of a defined band of pH levels.

13. The device of claim 1, further comprising a pump coupled between the measurement device and the environment, the pump configured to deliver the portion of the water from the environment to the measurement device.

14. A non-transitory computer-readable medium, comprising instructions for causing a computing device to perform a method of monitoring pH in a pool, the method comprising steps of:
a. testing a received water sample, the test for determining a pH level of the water sample; and
b. emitting a signal indicative of the determined pH level.

15. The medium of claim 14, wherein the emitting further comprises illuminating a light indicative of the determined pH level.

16. The medium of claim 14, wherein the emitting further comprises illuminating a light if the determined pH level is not within a predetermined pH level band.

17. The medium of claim 14, wherein the emitting further comprises rendering an audio signal if the determined pH level is not within a predetermined pH level band.

18. The medium of claim 14, wherein the emitting further comprises transmitting a signal to a receiver if the determined pH level is not within a predetermined pH level band.

19. The medium of claim 14, wherein the emitting further comprises transmitting a signal to a receiver corresponding to the determined pH level.

20. A method for monitoring pH in a pool, comprising:
a. using a device freely disposed in a pool, drawing water from the pool into a measurement chamber into a housing of the device;
b. using a measurement device within the housing of the device, measuring a pH level of the drawn water; and
c. using an indicator device, emitting a signal indicative of the measured pH, the emitted signal an audio signal, a visual signal, or an RF signal.
